(19) United States
(12) Patent Application Publication
(10) Pub. No.: US 2016/0232075 A1
(43) Pub. Date: Aug. 11, 2016

(54) APPARATUS AND METHOD FOR MEASURING SYSTEM AVAILABILITY FOR SYSTEM DEVELOPMENT

(71) Applicant: ELECTRONICS AND TELECOMMUNICATIONS RESEARCH INSTITUTE, Daejeon-si (KR)

(72) Inventors: Kwang Yong LEE, Daejeon-si (KR); Jung Hwan LEE, Daejeon-si (KR)

(21) Appl. No.: 14/989,082

(22) Filed: Jan. 6, 2016

(30) Foreign Application Priority Data
Feb. 11, 2015 (KR) 10-2015-0021205

(51) Int. Cl. G06F 11/36

(52) U.S. Cl. CPC G06F 11/3608

(57) ABSTRACT

Disclosed is an apparatus and method for measuring system availability for system development. The method of measuring availability of a system includes: generating an error in the system and detecting a fault to measure a Mean Time To Repair (MTTR); and measuring the availability of the system by using the measured MTTR.

### CROSS-REFERENCE TO RELATED APPLICATION(S)

This application claims priority from Korean Patent Application No. 10-2015-0021205, filed on Feb. 11, 2015, in the Korean Intellectual Property Office, the entire disclosure of which is incorporated herein by reference for all purposes.

### BACKGROUND

1. Field

The following description generally relates to a technology for system development, and more particularly to an availability measurement technology for system development.

2. Description of the Related Art

Software prototyping is a method of creating a model for a software product before beginning to build a software system or a hardware system, in which tests are performed in advance to verify its validity or to evaluate performance. The prototyping may include various types according to purposes, and may be largely divided into two types of an experimental prototype and an evolutionary prototype. The evolutionary prototype uses requirement analysis tools and continuing to develop a built prototype to manufacture a final product. Generally, a method of developing the evolutionary prototype includes combining advantages of a waterfall model and a prototyping model to strengthen risk management, in which a final product may be achieved by continuously developing a prototype.

### SUMMARY

Provided is an apparatus and method for measuring system availability, which enables rapid measurement of availability for system development.

In one general aspect, there is provided a method of measuring availability of a system, the method including: generating an error in the system and detecting a fault to measure a Mean Time To Repair (MTTR); and measuring the availability of the system by using the measured MTTR.

The measuring of the MTTR may include executing the system to repair the fault in response to the error periodically generated by an error generator.

The method may further include fixing a Mean Time To Failure (MTTF) at a constant value, wherein the measuring of the availability of the system may include measuring the availability of the system by using the MTTF fixed at the constant value and the measured MTTR.

The method may further include: providing a result of measurement; and analyzing the result of measurement to provide a result of the analysis.

The providing of the result of the analysis may include: analyzing MTTR elements to provide an element to be minimized for optimization of the system; and estimating an availability value of the system optimized by minimizing the element to provide the estimated availability value.

In another general aspect, there is provided a method of measuring availability of a system, the method including: generating an error in the system at an availability measuring agent by using an error generator to measure Mean Time To Repair (MTTR) elements; and receiving, at an availability measuring client, the measured MTTR elements from the availability measuring agent to measure the MTTR elements, and to measure the availability of the system by using the measured MTTR elements and a predetermined a Mean Time To Failure (MTTF).

The MTTR elements may include an error detection time, a mode switch time for mode switch between a master system and a backup system, and a connection time for connection of the master system with a client system.

The measuring of the MTTR elements may include: generating an error at the availability measuring agent by using the error generator; detecting the generated error; switching a mode between the master system and the backup system to repair the generated error; and upon switching the mode, measuring the MTTR elements for repair.

The method may further include: storing the measured MTTR elements as data in an XML format; and providing the stored data in the XML format to the availability measuring client.

The providing of the data to the availability measuring client may include: opening, at the availability measuring client, a socket for communication with the availability measuring agent, and requesting connection from the availability measuring agent; transmitting, at the availability measuring agent, an approval message to the availability measuring client; upon receiving the approval, transmitting, at the availability measuring client, a Listen signal to the availability measuring agent; and providing, at the availability agent, the MTTR elements in the XML format to the availability measuring client.

The generating of the error may include: setting a generation time and a generation mode;
checking the set mode and determining an interval value according to whether the set value is a random value or a periodic value; upon sleeping for the determined interval, setting an executable error file; and executing the set executable error file.

The setting of the executable error file may include: declaring an integer type variable i; reading information on a storage path of error files of an executable file, and putting the error files in an i-th row one by one starting from 0 until the i becomes greater than a number of files; and in response to the i becoming greater than the number of files, returning the error files.

The detecting of the error may include: reading an error detecting file to set a system state threshold; reading system state information to check current system state information; and upon comparing the system state threshold with current system state information, in response to the current system state information being greater than the system state threshold, determining that there is the error.

The switching of the mode may include: upon detecting, at the availability measuring agent, the error within the error detection time, transmitting a mode switch request to the master system and the backup system; receiving a response message, indicating that the mode switch is ready, from the master system and the backup system; upon receiving, at the availability measuring agent, the response message, transmitting a sleep message to the master system so that the master system is converted into a backup mode to stop providing a service to a client system; and transmitting a WAKE_UP message to the backup system so that the backup system is converted into a master mode to resume providing the service to the client system.

In yet another general aspect, there is provided an apparatus for measuring availability of a system, the apparatus comprising: an availability measuring agent configured to generate an error in the system by using an error generator to measure Mean Time To Repair (MTTR) elements; and an availability measuring client configured to receive the measured MTTR elements from the availability measuring agent to measure the MTTR elements, and to measure the availability of the system by using the measured MTTR elements.

The availability measuring agent may execute the system to repair the fault in response to the error periodically generated by an error generator.

The MTTR elements may include an error detection time, a mode switch time for mode switch between a master system and a backup system, and a connection time for connection of the master system with a client system.

The availability measuring client may fix a Mean Time To Failure (MTTF) at a constant value, and may measure the availability of the system by using the MTTF fixed at the constant value and the measured MTTR. The availability measuring client may analyze a result of the measurement to provide a result of the analysis along with the result of the measurement. The system may be a duplex embedded system that executes software.

### BRIEF DESCRIPTION OF THE DRAWINGS

FIG. 1A is a graph illustrating a general method of developing an evolutionary prototype, and FIG. 1B is a graph illustrating a Spiral model of the evolutionary prototype developed by the general method.

FIG. 2A is a flowchart illustrating a method of developing an evolutionary prototype by using an apparatus for measuring availability according to an exemplary embodiment, and FIG. 2B is a graph illustrating a Spiral model of an evolutionary prototype developed by the method according to an exemplary embodiment.

FIG. 3 is a diagram illustrating a system environment for measuring availability according to an exemplary embodiment.

FIG. 4 is a diagram illustrating a duplex embedded system for measuring availability according to an exemplary embodiment.

FIG. 5A is a diagram illustrating a required time in a general method of measuring availability, and FIG. 5B is a diagram illustrating a required time in a method of measuring availability by automatically generating errors according to an exemplary embodiment.

FIG. 6 is a flowchart illustrating an automatic error generation process by using an automatic error generator according to an exemplary embodiment.

FIG. 7 is a flowchart illustrating in detail a process of setting an executable error file in FIG. 6 according to an exemplary embodiment.

FIG. 8 is a flowchart illustrating a process of measuring availability according to an exemplary embodiment.

FIG. 9 is a flowchart illustrating a process of detecting an error according to an exemplary embodiment.

FIG. 10 is a flowchart illustrating a process of mode switch between a master system and a backup system by using an availability measuring agent according to an exemplary embodiment.

FIG. 11 is a diagram illustrating XML data including information on MTTR elements.

FIG. 12 is a flowchart illustrating a process of transmitting and receiving messages between an availability measuring client and an availability measuring agent by using a protocol according to an exemplary embodiment.

FIG. 13 is a flowchart illustrating a detailed process of risk analysis focusing on availability (step II in FIG. 2) according to an exemplary embodiment.

FIG. 14 is a logarithmic chart illustrating a measurement result of availability by minimizing MTTR according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, the present disclosure will be described in detail with reference to the accompanying drawings. The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. Terms used throughout this specification are defined in consideration of functions according to exemplary embodiments, and can be varied according to a purpose of a user or manager, or precedent and so on. Therefore, definitions of the terms should be made on the basis of the overall context.

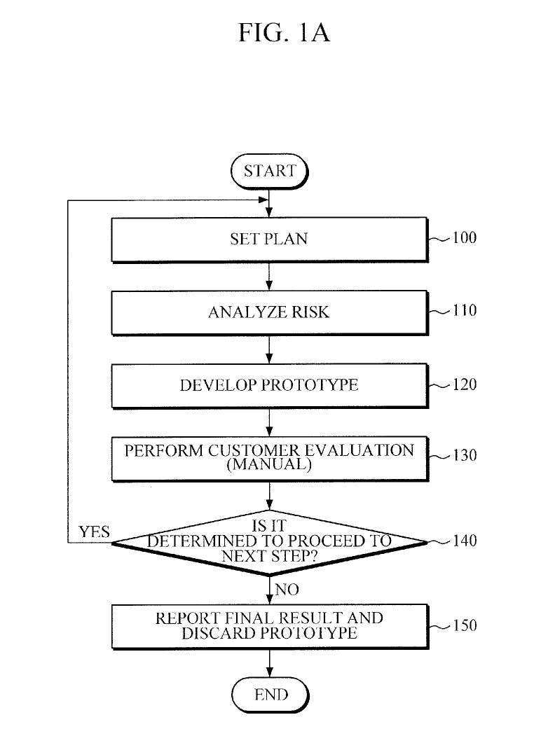

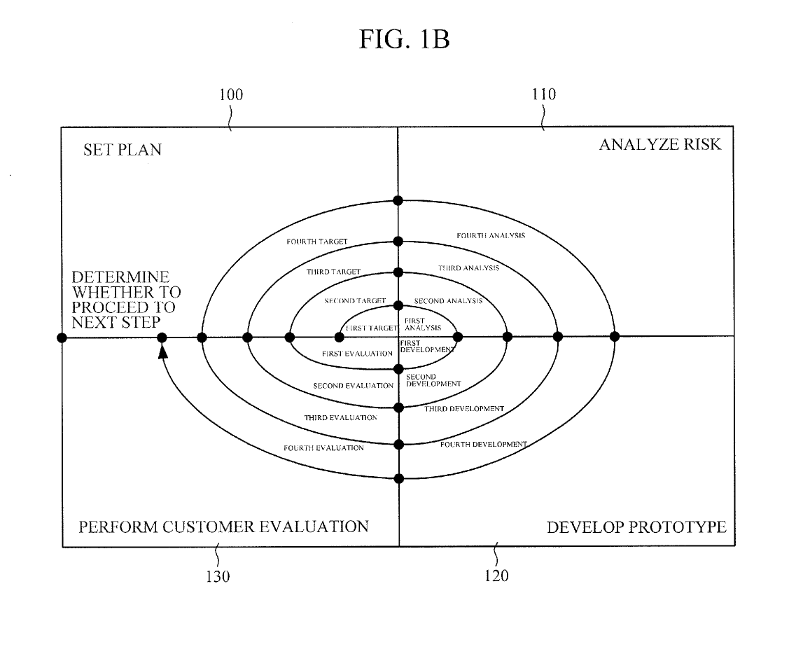

FIG. 1A is a graph illustrating a general method of developing an evolutionary prototype, and FIG. 1B is a graph illustrating a Spiral model of the evolutionary prototype developed by the general method.

Referring to FIG. 1A, the general method of developing an evolutionary prototype is a method that may strengthen risk management by combining advantages of a waterfall model and a prototyping model, in which a prototype is continuously developed until final software is built. In the method, functions of software are divided so that software may be incrementally developed according to the divided functions. A typical example thereof is a Spiral model as illustrated in FIG. 1B. The Spiral model is a method that repeats planning in 100. risk analysis in 110, prototype development in 120, and customer evaluation in 130 until final software is built. Following the customer evaluation in 130, determination in 140 on whether to proceed to a next step is made to report a final result, and then a prototype is discarded in 150, or a process is returned to a step of resetting a plan. The customer evaluation in 130 is performed based on a developer's manual. The evolutionary prototype model has a drawback in that it is uneconomical to discard a prototype in 150 after an evaluation step, and particularly if there is no risk analysis or solution, the model may be even more risky.

The present disclosure combines advantages of the waterfall model and the prototyping model, and uses an apparatus for rapidly measuring availability to set a baseline for a next step and to strengthen risk management. Availability may be measured rapidly by using an automatic error generator, such that a prompt decision may be made to reach an availability target. Further, in the present disclosure, by continuously developing an actual object, rather than developing a prototype, final software may be built in an economic manner, and software functions are divided so that software may be incrementally developed according to its divided functions.

Availability refers to the ability of information system, such as servers, networks, and programs, to be continuously operational. Generally, availability may be obtained by dividing a Mean Time To Failure (MTTF) by MTTF+MTTR. A system having high availability is called a high availability system. In order to secure a high availability system, the MTTF should be maximized while minimizing a Mean Time To Repair (MTTR).

In the method of developing an evolutionary system, availability of a system is evaluated in an evaluation step, and a target is set as a baseline for a next step based on the evaluation. However, in the general method of measuring availability, a system is operated for a long duration to measure the MTTF and MTTR, and availability is measured based on the measured values. In order to measure the MTTF, a period of time until an error occurs is required to be measured, such that measurement should be performed for an extended period of time ranging from a week to several months. For this reason, the general method, which requires a long duration to identify a system level, is not efficient.

However, the present disclosure provides an apparatus for rapidly measuring availability, which fixes the MTTF at a specific constant value, and measures only the MTTR by using an automatic error generator in a short period of time, thereby enabling rapid measurement of availability and decision making. For example, if a fault in a system that provides data streaming is repaired within 500 msec, the system may provide a client system with seamless services, such that the system is assumed to have an availability of 5-nines (99.999%). As it is assumed that the MTTR is 500 msec in the system having 99.999% availability, the MTTF may be fixed at 49999.5 seconds calculated by using a numerical formula of availability. In the case where errors are generated every 30 seconds by using an automatic error generator with the MTTF being fixed, average availability values may be measured 240 times in two hours. Further, by providing a developer with data of required time for MTTR elements, a developer may identify an optimization point in the analysis step. For example, in a duplex system that repairs faults by mode switch, if three types of time periods, i.e., an error detection time (a), a mode switch time (B), and a connection time (y) are required, a required time for each element is analyzed to set an element to be minimized as a target, so that an optimization point may be identified to determine a required time to be optimized.

Services should be provided seamlessly in an embedded system used for mobile terminals, network equipment, vehicles, airplanes, and the like. For example, Nonstop Routing (NSR) network equipment, which is required to provide client systems with seamless services, should set a target availability to provide services, and its system should be optimized. In the above system. by using an evolutionary prototype model, the system may be continuously developed to achieve a final target. However, the evolutionary prototype is a risky model if there is no solution in the risk analysis step. In order to overcome such drawback, the present disclosure provides an apparatus for rapidly measuring availability using the general evolutionary method to manage risk of a developing project. While a general apparatus for measuring availability, which requires a long period of time, is inefficient in optimizing a system, the apparatus for measuring availability according to the present disclosure may improve the drawback to measure availability rapidly.

In the present disclosure, the apparatus for rapidly measuring availability may rapidly determine whether to proceed to a next step and may set an availability target. Further, the present disclosure is distinct from the general method in that by comparing the measured availability with the target availability, an optimization point may be identified to provide risk analysis and a solution. Hereinafter, the method of developing an evolutionary prototype according to the present disclosure will be described below in detail with reference to the accompanying drawings.

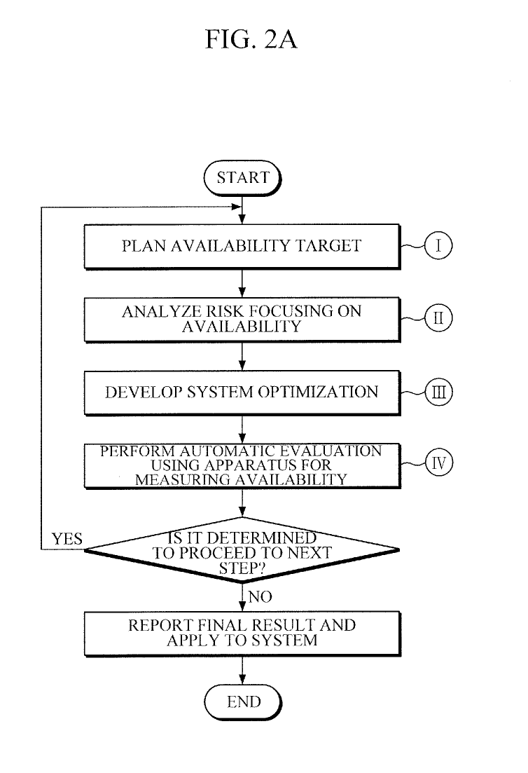

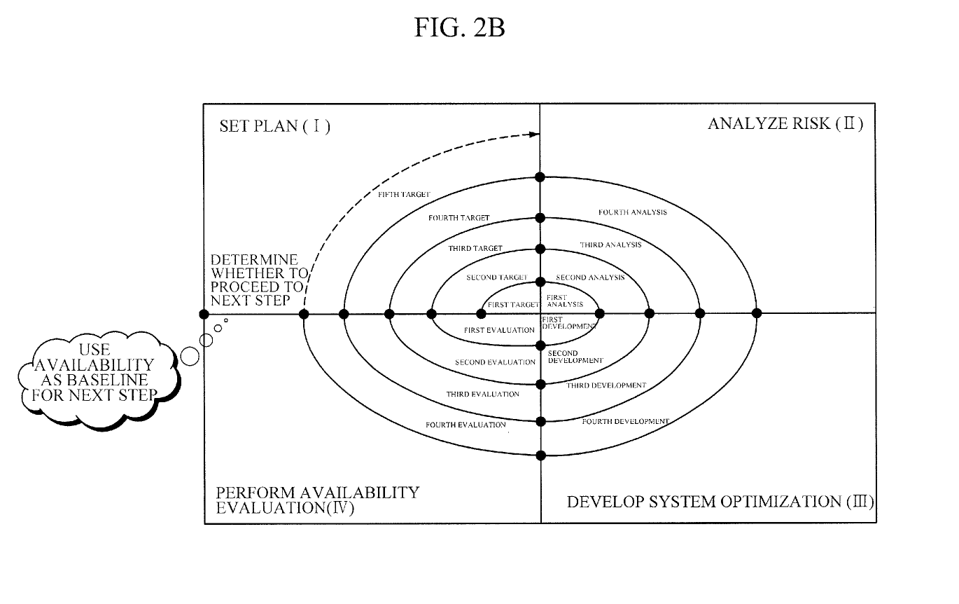

FIG. 2A is a flowchart illustrating a method of developing an evolutionary prototype by using an apparatus for measuring availability according to an exemplary embodiment, and FIG. 2B is a graph illustrating a Spiral model of an evolutionary prototype developed by the method according to an exemplary embodiment.

Referring to FIG. 2A, the method of developing an evolutionary prototype by using an apparatus for measuring availability includes: step I of planning an availability target based on measurement results of availability; step II of risk analysis focusing on availability by identifying a direction of development based on an optimization point, and by comparing a target availability with an estimated availability; step III of developing system optimization by using an optimization point; and step IV of evaluating availability after the optimization by using an automatic apparatus for measuring availability. As illustrated in FIG. 2B, by using a Spiral model that continuously processes the above four steps I, II, III, and IV, a system may be optimized, and final software may be built.

In step IV of evaluating availability, availability may be rapidly evaluated by using an apparatus for measuring availability that uses an automatic error generator. To this end, in response to errors periodically generated by the automatic error generator, the apparatus for measuring availability executes a system to repair faults and automatically extracts the MTTR. Then, availability of a system may be evaluated based on the measured MTTR and a predetermined MTTF. Subsequently, by comparing the measured availability with a target availability that has been initially set. it is determined whether to proceed to a next step. If the measure availability is lower than the target availability set in the step of planning an availability target, the process is returned to step 1 of planning an availability target, so as to reset an availability target by using the measured availability values.

In step II of risk analysis focusing on availability, required time for MTTR elements is analyzed to determine an element to be optimized, a system is optimized by minimizing the MTTR to obtain estimation of the maximum availability, and risk is analyzed by comparing the estimated availability and the target availability.

In step III of developing system optimization, availability is improved by developing an optimized element set in the previous step.

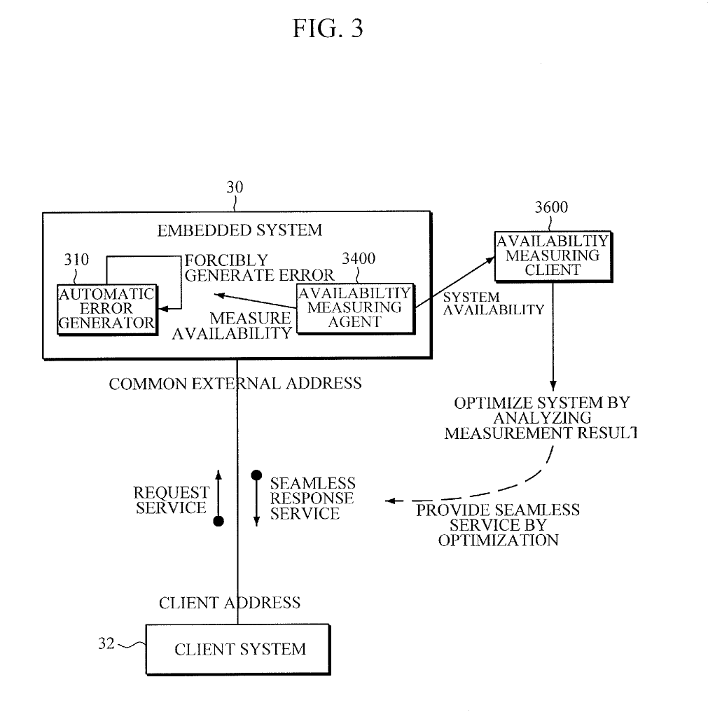

FIG. 3 is a diagram illustrating a system environment for measuring availability according to an exemplary embodiment.

Referring to FIG. 3, availability may be measured in a duplex embedded system 30. The embedded system 30 uses a fault tolerant method to increase availability of a system itself. In the fault tolerant method, a system is activated to operate as a master system, and the rest systems are deactivated or are in a waiting state until a fault occurs in the master system, and when a fault occurs in the master system, the rest systems operate in a master mode to minimize interruptions of services provided to client systems.

An availability measuring agent 3400 for measuring availability is embedded in a master-backup processor of the embedded system 30. In response to a request of a client system 32 located at a peer position, the embedded system 30 provides high reliability and high availability services, i.e., nonstop service experience. The embedded system 30 may be, for example, network equipment such as smart gateway equipment for vehicles, but is not limited thereto.

In a reference hardware model, the embedded system 30 uses a common external address, e.g., a common external IP address. Further, the embedded system 30 provides seamless services to the client system 32 located at a peer position without allowing the client system 32 to notice that a system is changed to a backup system due to a fault occurring in a master system.

In one exemplary embodiment, the embedded system 30 may enable rapid mode switch and rapid service resumption, i.e., a short MTTR, so that services may be provided seamlessly to the client system 32. To this end, the availability measuring agent 3400 forces errors to be generated by the automatic error generator 310, measures the required time for MTTR elements, and provides the measured values to an availability measuring client 3600, thereby enabling the MTTR to be measured in a short time.

The availability measuring client 3600 measures the MTTF, which is a fixed constant value, and availability by using the required time for MTTR elements that is received from the availability measuring agent 3400. In one exemplary embodiment, the availability measuring client 3600 may enable a developer to develop a high availability system in a short time by providing information on an optimization point so that the developer may preferentially optimize an element with much overhead among the measured required time for MTTR elements.

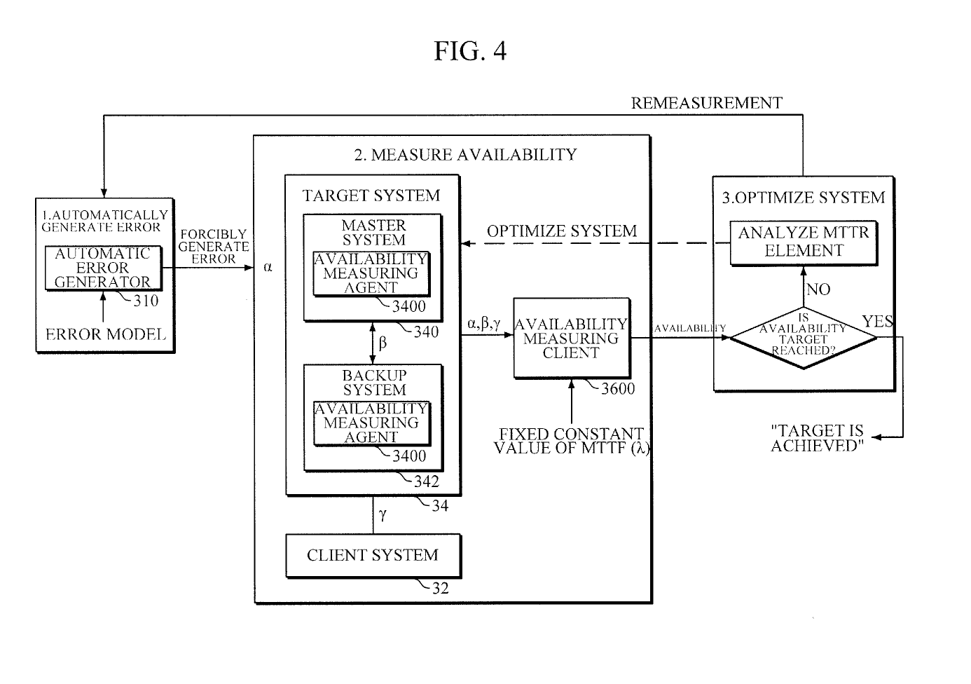

FIG. 4 is a diagram illustrating a duplex embedded system for measuring availability according to an exemplary embodiment.

Referring to FIG. 4, a target system 34 provides seamless services to a client system 32 located at a peer position. The client system 32 is a system that corresponds to the target system 34. The target system 34 and the client system 32 are systems, including network equipment such as routers or gateways, hubs, personal computers, servers, hosts, and the like, but are not limited thereto. The target system 34 and the client system 32 include an availability measuring agent 3400. The target system 3 is an embedded system that includes a master system 340 and a backup system 342.

The availability measuring agent 3400 and the availability measuring client 3600, each as a software module, may operate in a hardware device. In this case, the availability measuring agent 3400 operates in the target system 34 of which availability is to be measured, and the availability measuring client 3600 may operate in a terminal that directly interfaces with a developer. For example, the availability measuring agent 3400 may operate in the target system 34, and the availability measuring client 3600 may operate in a terminal such as a smart pad of a developer.

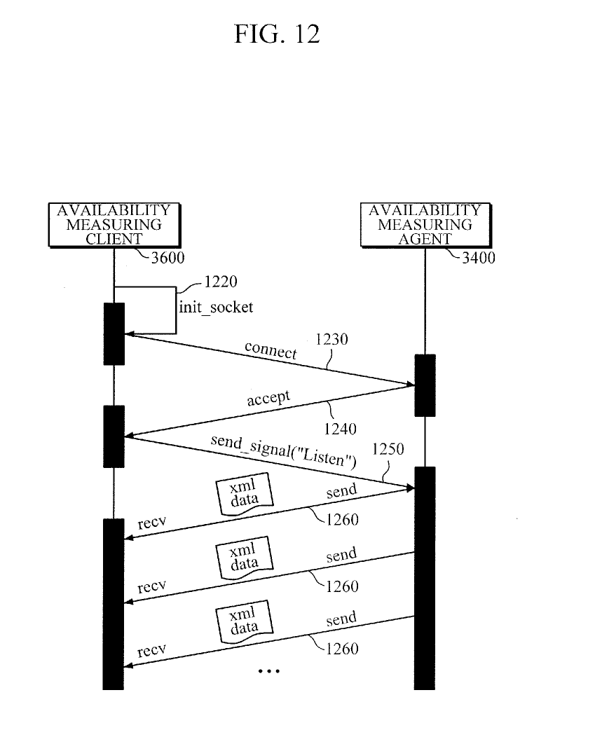

In one exemplary embodiment, the availability measuring agent 3400 and the availability measuring client 3600 are connected through a network to transmit and receive messages by using protocols. A process of transmitting and receiving messages between the availability measuring agent 3400 and the availability measuring client 3600 will be described in detail later with reference to FIG. 12.

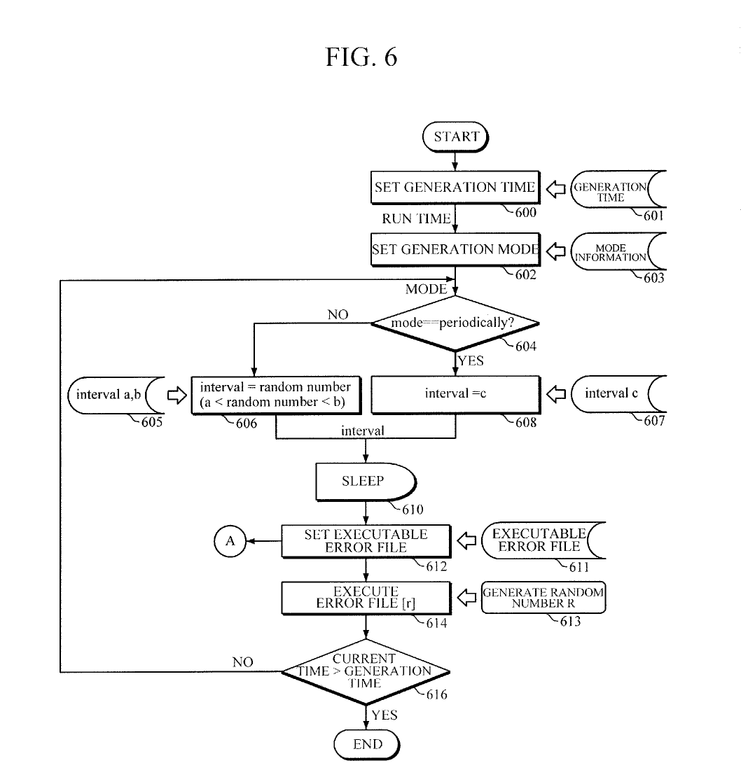

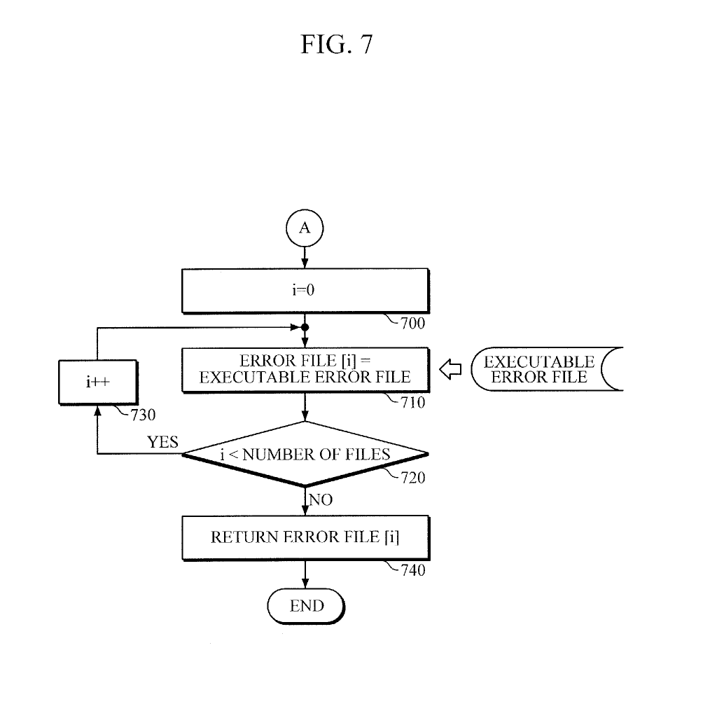

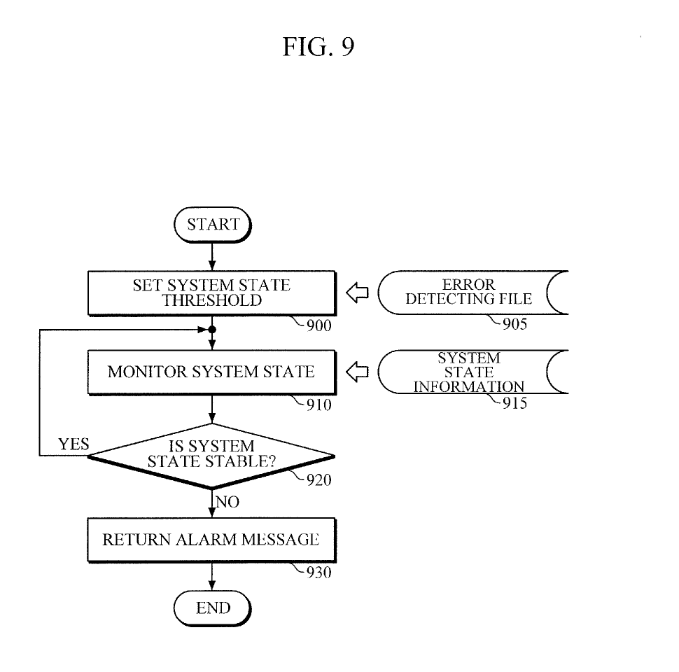

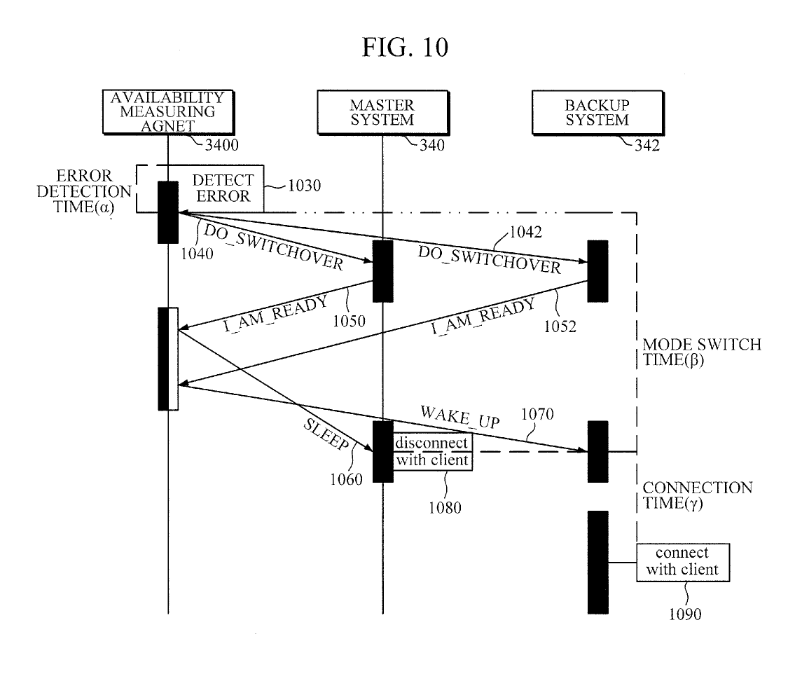

The availability measuring agent 3400 automatically generates various errors by using the automatic error generator 310, detects the generated errors, and performs mode switch between the master system 340 and the backup system 342. The process of generating errors by using the automatic error generator 310 will be described in detail later with reference to FIGS. 6 and 7. Further, the process of detecting errors will be described in detail later with reference to FIG. 9. In addition, the process of mode switch will be described in detail later with reference to FIG. 10.

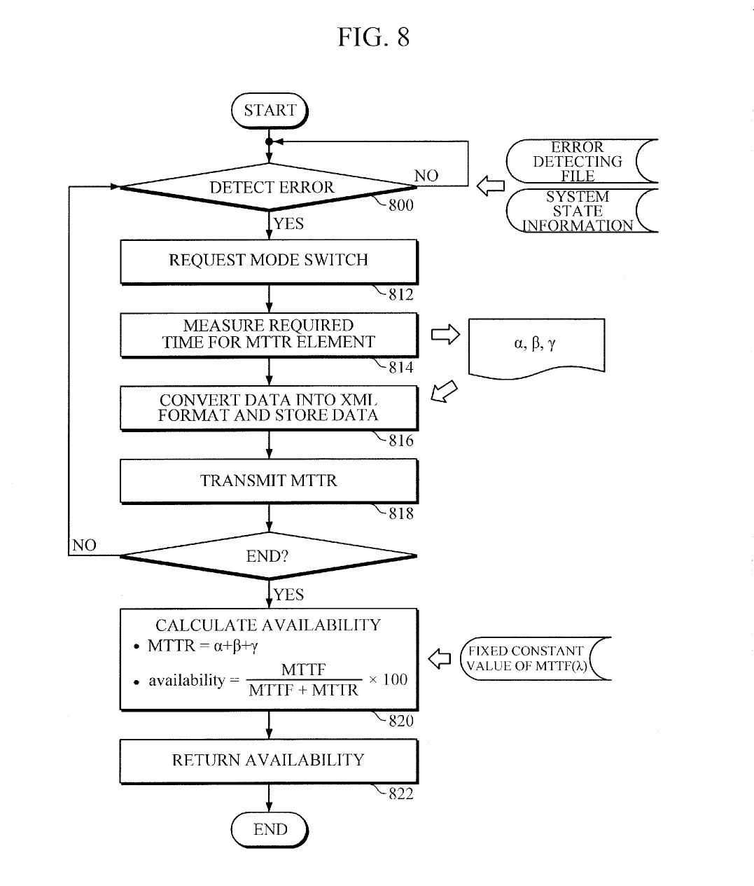

When switching a mode, the availability measuring agent 3400 measures required time for MTTR elements, including an error detection time (a), a mode switch time (B), and a connection time (y), and transmits the measured values to the availability measuring client 3600. By using the error detection time (a), the mode switch time (B), and the connection time (y) that are received from the availability measuring agent 3400, the availability measuring client 3600 measures the MTTF, which is a fixed constant value, and availability. The process of calculating availability at the availability measuring agent 3400 and the availability measuring client 3600 will be described in detail later with reference to FIG. 8.

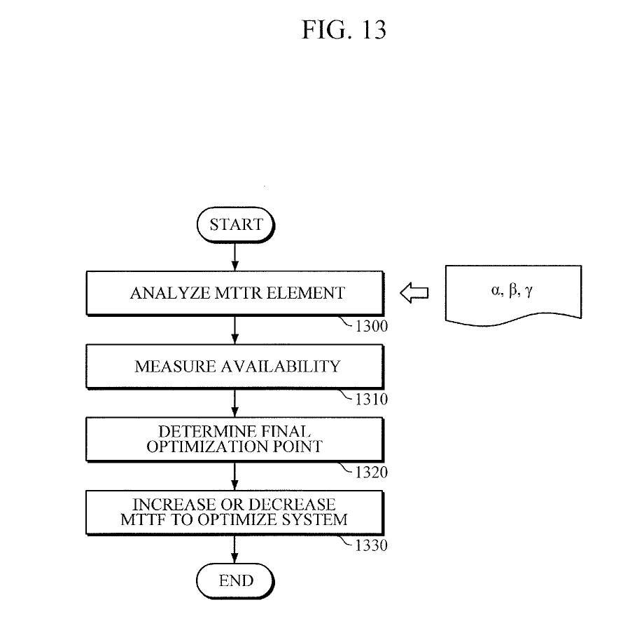

In one exemplary embodiment, the availability measuring client 3600 provides the measurement results to a system developer. In this case, the availability measuring client 3600 may analyze the measurement results, and may provide results of the analysis to the developer. The system developer checks whether an availability value measured by the availability measuring client 3600 reaches a target availability set in the step of planning an availability target, and in response to the measured availability not reaching the target availability, a system is optimized by analyzing MTTR elements. The system optimization process will be described in detail later with reference to FIG. 13.

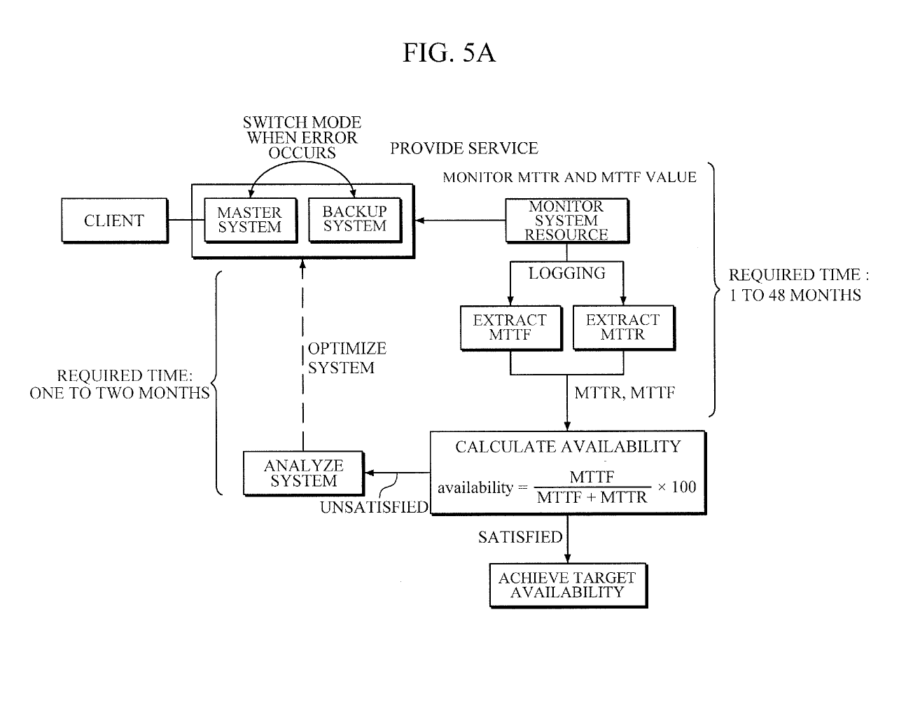

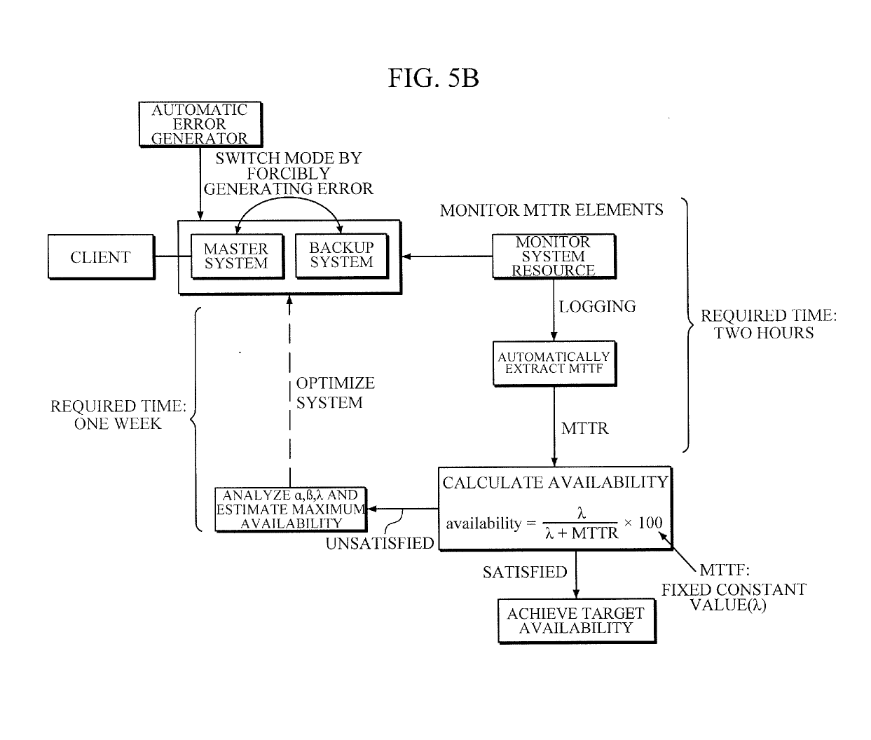

FIG. 5A and FIG. 5B are diagrams to compare a general method of measuring availability with a method of measuring availability by automatically generating errors according to an exemplary embodiment of the present disclosure, in which FIG. 5A is a diagram illustrating a required time in a general method of measuring availability, and FIG. 5B is a diagram illustrating a required time in a method of measuring availability by automatically generating errors according to an exemplary embodiment.

The present disclosure provides the method of measuring availability that may solve a problem of a general method of measuring availability. In the general method of measuring availability, availability is calculated by operating a system for a long period of time to measure the MITE and MTTR. In order to measure the MTTF, it is necessary to measure a period of time until an error occurs, such that measurement should be performed for an extended period of time. For example, in the general method of measuring availability, it takes 1 to 48 months to monitor a system to measure the MITE and MTTR.

By contrast, in the present disclosure, with the MTTF being fixed at a constant value, an error is generated by the automatic error generator, and only the MTTR is measured in a short time, such that system availability may be measured rapidly. In this case, a short time period, e.g., two hours, is required to monitor system resources and to measure the MTTR, thereby enabling a developer to make a prompt decision.

In order to determine a fixed constant value of the MTTF, empirical facts are required.

For example, in the network field, if a fault is repaired within 500 msec, a system is assumed to have a high availability of 5-nines (99.999%). Based on the assumption, a fixed constant value of the MTTF may be obtained as shown in Equation (b) by substituting the following availability Equation (a).

TABLE 1

(a) Availability (%) = MTTF/(MTTF + MTTR) × 100
(b) 99.999% = λ/(λ + 0.5 sec) × 100, λ = 49999.5 sec.

In the present disclosure, after measuring the MTTR, availability may be measured by using the measured MTTR and a fixed MTTF value (k).

A system developer checks whether an availability reaches a target availability, and in response to the measured availability not reaching the target availability, a system is optimized by analyzing MTTR elements and by obtaining estimation of the maximum availability. A required time for optimizing a system is about one week, which is significantly shorter than a general method requiring one or two months. The above time period is merely illustrative to compare the present disclosure to the general method, such that the required time may vary depending on system environments.

FIG. 6 is a flowchart illustrating an automatic error generation process by using an automatic error generator according to an exemplary embodiment.

Referring to FIG. 6, in the process of setting a generation time in 600, an apparatus for measuring availability reads a generation time by using an executable file (autogen.cfg), and returns the generation time. Then, in the process of setting a generation mode in 602, the apparatus for measuring availability reads mode information in 603, and returns the mode. Subsequently, the apparatus for measuring availability checks the returned mode value in 604, in which in response to the mode value being mode==randomly, the apparatus reads two integers a and b in 605 to generate a random value (a<random number<b), substitutes the generated random value into an interval value in 606, and returns the interval; by contrast, in response to the mode value being mode==periodically, the apparatus reads only one integer c in 607 from the executable file (autogen.cfg), substitutes the integer into the interval, and returns the interval.

Then, after sleeping during an interval in 610, the apparatus reads an executable error file in 611 to set an executable error file in 612, generates a random number r in 613 to execute an error file that is in an r-th row in 614, and checks whether a current time is greater than the generation time in 616. In response to the current time being greater than the generation time, a program is terminated, and in response to the current time not being greater than the generation time, the process proceeds to a step of obtaining an interval, and periodically generates errors.

FIG. 7 is a flowchart illustrating in detail a process of setting an executable error file in FIG. 6 according to an exemplary embodiment.

Referring to FIGS. 6 and 7, the apparatus for measuring availability declares an integer type variable i, and reads information on a storage path of an error file of an executable file(autogen.cfg), in which the apparatus puts error files in an i-th row one by one starting from 0 until i becomes greater than the number (integer) of files in 700 to 730. The apparatus checks whether i becomes greater than the number of files in 720, and in response to i being greater than the number of files, the apparatus returns the error files in an i-th row in 740.

FIG. 8 is a flowchart illustrating a process of measuring availability according to an exemplary embodiment.

Referring to FIGS. 4 and 8, once an error is generated by the automatic error generator 310, the availability measuring agent 3400 detects the generated error in 800, and transmits a mode switch request to the master system 340 and the backup system 342. In this case, the mode switch request may be transmitted through a master-backup system mode switch protocol. Once a mode is switched, the availability measuring agent 3400 extracts MTTR elements in 814. In this case, the extracted data may be converted into an XML format and is stored in 816. Then, the data in an XML format is periodically transmitted to the availability measuring client 3600 in 818.

The availability measuring client 3600 calculates availability in 820 by using the MTTR and MTTF that are received from the availability measuring agent 3400, and returns the measured availability value in 822.

FIG. 9 is a flowchart illustrating a process of detecting an error according to an exemplary embodiment.

Referring to FIG. 9, the availability measuring agent reads an error detecting file (errordetect.cgf) in 905 to set a system state threshold in 900. For example, in order to check whether a system CPU usage exceeds 90%, the threshold is set to be 90.

Subsequently, system state information is read in 915 as top data provided by an OS to monitor a current state of the system in 910. Then, it is determined in 920 whether a system state is stable, in which upon comparing current system state information with the system state threshold, in response to the current system state information being greater than the system state threshold, an alarm message is returned in 930 so that a system may be recovered by mode switch.

FIG. 10 is a flowchart illustrating a process of mode switch between a master system and a backup system by using an availability measuring agent according to an exemplary embodiment.

In the duplex embedded system that provides services, the master system 340 provides services to a client system, and the backup system 342 is in a waiting state for a mode switch, and once a mode is switched, the backup system 342 is switched into a master mode to provide services to the client system.

Upon detecting an error within an error detection time (a) in 1030, the availability measuring agent 3400 transmits a DO_SWITCHOVER message to request mode switch from the master system 340 and the backup system 342 in 1040 and 1042, and receives an I_AM_READY message, indicating that the mode switch is ready, from the master system 340 and the backup system 342 in 1050 and 1052. Upon receiving the I_AM_READY message, the availability measuring agent 3400 transmits a sleep message to the master system 340 in 1060 so that the master system 340 may be switched into a backup mode to be disconnected with a client system in 1080. By contrast, the availability measuring agent 3400 transmits a WAKE_UP message to the backup system 342 in 1070 so that the backup system 342 may be switched into a master mode to be connected with a client system in 1090.

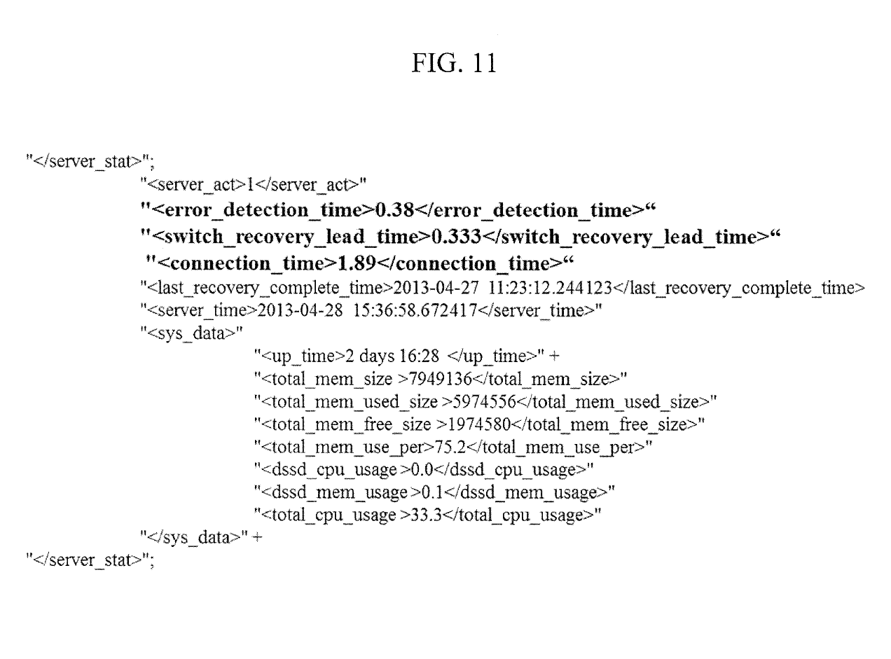

FIG. 11 is a diagram illustrating XML data including MTTR elements.

Referring to FIG. 11, MTTR elements extracted by the availability measuring agent 3400 are stored, and the stored data is converted into an XML format to be transmitted to the availability measuring client 3600. MTTR elements include an error_detection_time, a switch_recovery_lead_time, and a connection_time.

FIG. 12 is a flowchart illustrating a process of transmitting and receiving messages between an availability measuring client and an availability measuring agent by using a protocol according to an exemplary embodiment.

Referring to FIG. 12, the availability measuring agent 3400 transmits MTTR data in an XML format to the availability measuring client 3600. To this end, the availability measuring client 3600 opens a socket (init_socket) for communication with the availability measuring agent 3400 in 1220, and requests connection in 1230. The availability measuring agent 3400 returns an accept message to approve connection in 1240. Upon receiving the approval, the availability measuring client 3600 transmits a Listen signal to the availability measuring agent 3400 in 1250, and the availability measuring agent 3400 transmits the MTTR data in an XML format to the availability measuring client 3600 in 1260.

FIG. 13 is a flowchart illustrating a detailed process of risk analysis focusing on availability (step II in FIG. 2) according to an exemplary embodiment.

Referring to FIG. 13, MTTR elements are analyzed to determine an element that is required to be minimized for system optimization in 1300. For example, if an average error detection time (α) is 0.38 seconds, an average mode switch time ( [symbol] ) is 0.42 seconds, an average connection time ( [symbol] ) is 2.17 seconds, which leads to the MTTR of 2.97 seconds (0.38+0.42+2.17), it can be seen that the connection time ( [symbol] ), which is the longest required time, should be minimized.

Subsequently, a target element ( [symbol] in the above example) is minimized for optimization and then an estimation of the maximum availability is obtained in 1310. In the above example, assuming that the MTTF is 14 hours, and the connection time ( [symbol] ) is minimized from 2.17 seconds to 1 second, an availability may be estimated to be 99.996%.

Then, a final optimization point is determined by using measurement results of availability and estimated availability values in 1320. There is a possibility that a target availability may be satisfied through a repeated process of optimization by minimizing the MTTR, but if a target availability is too high, system availability may not reach the target.

In the determination of the final optimization point in 1320, it is determined whether to minimize the MTTR or to increase the MTTF for system optimization, and a system is optimized by using a determined method in 1330. In the case where a system is optimized by reducing the MTTF, an element to be minimized is determined, and an optimization point is determined. A system for improving availability is developed by using a determined optimization point in the step of developing system optimization (step HI in FIG. 2). After optimization, the process is returned to the step of availability evaluation (step IV in FIG. 2) to measure system availability, and it is determined whether to proceed to a next step.

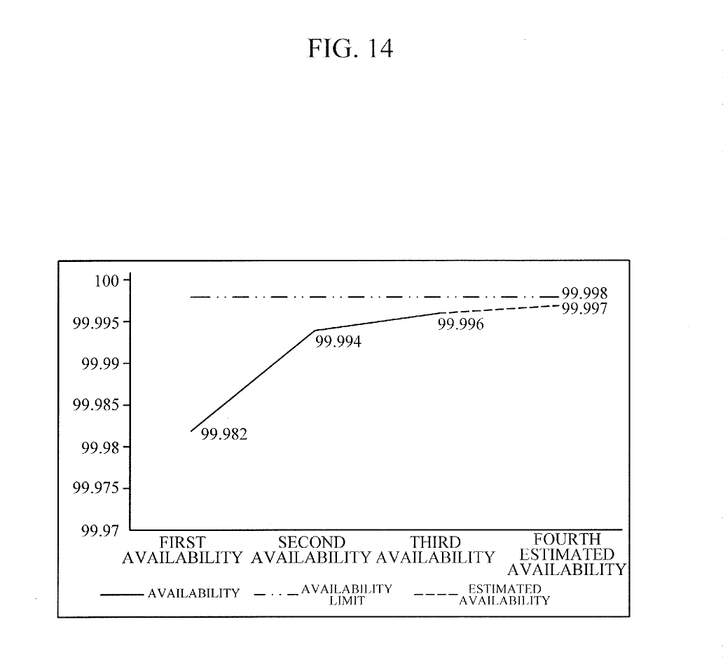

FIG. 14 is a logarithmic chart illustrating a measurement result of availability by minimizing an MTTR according to an exemplary embodiment.

Referring to FIG. 14, it can be seen that as an optimization process is repeated by minimizing the MTTR, an improvement degree of availability is reduced to converge on an availability limit. After a first process of optimization, availability is significantly increased by 0.012% (from 99.982% to 99.994%); after a second process of optimization, availability is merely increased by 0.002% (from 99.994% to 99.996%); and after a third process of optimization, a degree of availability improvement is estimated to be very small. Based on the result, it can be seen that even if optimization is performed without limitation by minimizing the MTTR, availability may not exceed the limit of 99.998%.

As described above, in the apparatus and method for measuring system availability, a developer may promptly make decisions by rapidly measuring availability, may easily identify an optimization point, and may determine an optimization direction, so that a system may be easily developed. Accordingly, a target availability may be achieved in the development process that requires a high availability.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims. Further, the above-described examples are for illustrative explanation of the present invention, and thus, the present invention is not limited thereto.

What is claimed is:

1. A method of measuring availability of a system, the method comprising:
generating an error in the system and detecting a fault to measure a Mean Time To Repair (MTTR); and
measuring the availability of the system by using the measured MTTR.

2. The method of claim 1, wherein the measuring of the MTTR comprises executing the system to repair the fault in response to the error periodically generated by an error generator.

3. The method of claim 1, further comprising:
fixing a Mean Time To Failure (MTTF) at a constant value,
wherein the measuring of the availability of the system comprises measuring the availability of the system by using the MTTF fixed at the constant value and the measured MTTR.

4. The method of claim 1, further comprising:
providing a result of measurement; and
analyzing the result of measurement to provide a result of the analysis.

5. The method of claim 4, wherein the providing of the result of the analysis comprises:
analyzing MTTR elements to provide an element to be minimized for optimization of the system; and
estimating an availability value of the system optimized by minimizing the element to provide the estimated availability value.

6. A method of measuring availability of a system, the method comprising:
generating an error in the system at an availability measuring agent by using an error generator to measure Mean Time To Repair (MTTR) elements; and
receiving, at an availability measuring client, the measured MTTR elements from the availability measuring agent to measure the MTTR elements, and to measure the availability of the system by using the measured MTTR elements and a predetermined a Mean Time To Failure (MTTF).

7. The method of claim 6, wherein the MTTR elements comprise an error detection time, a mode switch time for mode switch between a master system and a backup system, and a connection time for connection of the master system with a client system.

8. The method of claim 6, wherein the measuring of the MTTR elements comprises:
generating an error at the availability measuring agent by using the error generator;
detecting the generated error;
switching a mode between the master system and the backup system to repair the generated error; and
upon switching the mode, measuring the MTTR elements for repair.

9. The method of claim 6, further comprising:
storing the measured MTTR elements as data in an XML format; and
providing the stored data in the XML format to the availability measuring client.

10. The method of claim 9, wherein the providing of the data to the availability measuring client comprises:
opening, at the availability measuring client, a socket for communication with the availability measuring agent, and requesting connection from the availability measuring agent;
transmitting, at the availability measuring agent, an approval message to the availability measuring client;
upon receiving the approval, transmitting, at the availability measuring client, a Listen signal to the availability measuring agent; and
providing, at the availability agent, the MTTR elements in the XML format to the availability measuring client.

11. The method of claim 8, wherein the generating of the error comprises:
setting a generation time and a generation mode;
checking the set mode and determining an interval value according to whether the set value is a random value or a periodic value;
upon sleeping for the determined interval, setting an executable error file; and
executing the set executable error file.

12. The method of claim 11, wherein the setting of the executable error file comprises:
declaring an integer type variable i;
reading information on a storage path of error files of an executable file, and putting the error files in an i-th row one by one starting from 0 until the i becomes greater than a number of files; and
in response to the i becoming greater than the number of files, returning the error files.

13. The method of claim 8, wherein the detecting of the error comprises:
to reading an error detecting file to set a system state threshold;
reading system state information to check current system state information; and
upon comparing the system state threshold with current system state information, in response to the current system state information being greater than the system state threshold, determining that there is the error.

14. The method of claim 8, wherein the switching of the mode comprises:
upon detecting, at the availability measuring agent, the error within the error detection time, transmitting a mode switch request to the master system and the backup system;
receiving a response message, indicating that the mode switch is ready, from the master system and the backup system;
upon receiving, at the availability measuring agent, the response message, transmitting a sleep message to the master system so that the master system is converted into a backup mode to stop providing a service to a client system; and
transmitting a WAKE_UP message to the backup system so that the backup system is converted into a master mode to resume providing the service to the client system.

15. An apparatus for measuring availability of a system, the apparatus comprising:
an availability measuring agent configured to generate an error in the system by using an error generator to measure Mean Time To Repair (MTTR) elements; and
an availability measuring client configured to receive the measured MTTR elements from the availability measuring agent to measure the MTTR elements, and to measure the availability of the system by using the measured MTTR elements.

16. The apparatus of claim 15, wherein the availability measuring agent executes the system to repair the fault in response to the error periodically generated by an error generator.

17. The apparatus of claim 15, wherein the MTTR elements comprise an error detection time, a mode switch time for mode switch between a master system and a backup system, and a connection time for connection of the master system with a client system.

18. The apparatus of claim 15, wherein the availability measuring client fixes a Mean Time To Failure (MTTF) at a constant value, and measures the availability of the system by using the MTTF fixed at the constant value and the measured MTTR.

19. The apparatus of claim 15, wherein the availability measuring client analyzes a result of the measurement to provide a result of the analysis along with the result of the measurement.

20. The apparatus of claim 15, wherein the system is a duplex embedded system that executes software.
